(19) United States
(12) Patent Application Publication
(10) Pub. No.: US 2015/0222201 A1
(43) Pub. Date: Aug. 6, 2015

(54) DUAL-ELEMENT POWER MODULE AND THREE-LEVEL POWER CONVERTER USING THE SAME

(71) Applicant: Yukio Nakashima, Chiyoda-ku (JP)

(72) Inventor: Yukio Nakashima, Chiyoda-ku (JP)

(73) Assignee: Mitsubishi Electric Corporation, Chiyoda-ku, Tokyo (JP)

(21) Appl. No.: 14/420,489

(22) PCT Filed: Aug. 10, 2012
(86) PCT No.: PCT/JP2012/070561

§ 371 Date: Feb. 9, 2015

(51) Int. Cl. H02M 7/537

(52) U.S. Cl. CPC H02M 7/537

(57) ABSTRACT

A first electrode that is connected to a higher-side potential portion of a first element pair, a second electrode that is connected to a connection portion between a lower-side potential portion of the first element pair and a higher-side potential portion of a second element pair, and a third electrode that is connected to a lower-side potential portion of the second element pair, are provided on one of the main-surface sides of a module casing. The first electrode and the third electrode are arrayed in a direction orthogonal to a longitudinal direction of the module casing on one of the end sides in the longitudinal direction. The second electrode is arranged on the other end side in the longitudinal direction of the module casing. Three dual-element triple-terminal power modules with the same configuration, configured as described above, are used to configure a three-level power converter of one phase.

### FIELD

The present invention relates to a dual-element power module and a three-level power converter using the dual-element power module.

### BACKGROUND

In a conventional railway-vehicle three-level power converter using a dual-element power module, among four switching elements that are connected in series to constitute upper and lower arms, outer switching elements (a switching element positioned on the higher potential side, and a switching element positioned on the lower potential side) are configured by a dual-element power module, and inner switching elements (two switching elements interposed between the two outer switching elements) are configured by a dual-element power module. Clamp diodes that are connected between a connection point between two switching elements that constitute the upper arm and a connection point between two switching elements that constitute the lower arm are configured by using separate diode modules (Patent Literature 1 mentioned below, for example).

### CITATION LIST

### Patent Literature

Patent Literature 1: International Publication No. WO 2008/075418

### SUMMARY

### Technical Problem

As described above, in the conventional railway-vehicle three-level power converter using a dual-element power module, the outer switching elements are configured by the dual-element power module, and the inner switching elements are configured by the dual-element power module. This results in a problem that the low-inductance structure within the module does not sufficiently contribute to functioning as a low-inductance circuit required for the railway-vehicle three-level power converter, and therefore the railway-vehicle three-level power converter cannot sufficiently take advantage of the features of the dual-element power module.

Patent Literature 1 mentioned above refers to an arrangement of the elements and positions of terminals in a dual-element power module. However, there is still room for improvement in the contribution of the arrangement of each module to achieving a low-inductance circuit required for the railway-vehicle three-level power converter. Therefore, a lower-inductance structure has been desired.

The present invention has been achieved to solve the above problems, and an object of the present invention is to provide a three-level power converter that can sufficiently take advantage of the features of a dual-element power module, and that can configure a lower-inductance circuit.

### Solution to Problem

To solve the above described problems and achieve the object according to the present invention a three-level power converter comprises a power-conversion circuit unit for one phase that selects any of potentials of a higher-side DC terminal, an intermediate-potential terminal, and a lower-side DC terminal, and that outputs the selected potential to an AC terminal. The power-conversion circuit unit includes: a first dual-element power module that includes an outer switching element on a higher potential side and a clamp element on the higher potential side; a second dual-element power module that includes an inner switching element on the higher potential side and an inner switching element on a lower potential side; and a third dual-element power module that includes an outer switching element on the lower potential side and a clamp element on the lower potential side. The first to third dual-element power modules are dual-element triple-terminal power modules with a same configuration, each of which including a first electrode that is connected to a higher-side potential portion of one of elements; a second electrode that is connected to a connection portion between a lower-side potential portion of the one of the elements and a higher-side potential portion of the other element; and a third electrode that is connected to a lower-side potential portion of the other element. The first electrode in the first dual-element power module is connected to the higher-side DC terminal. The second electrode in the first dual-element power module and the first electrode in the second dual-element power module are connected. The third electrode in the first dual-element power module is connected to the intermediate-potential terminal. The first electrode in the third dual-element power module is connected to the intermediate-potential terminal. The second electrode in the second dual-element power module is connected to the AC terminal. The third electrode in the second dual-element power module and the second electrode in the third dual-element power module are connected. And the third electrode in the third dual-element power module is connected to the lower-side DC terminal.

### Advantageous Effects of Invention

According to the present invention, a low-inductance circuit can be configured with three dual-element power modules having the same configuration.

### BRIEF DESCRIPTION OF DRAWINGS

FIG. 1 is a perspective view showing a schematic shape of a dual-element power module according to a first embodiment of the present invention.

FIG. 2 is a circuit diagram of the dual-element power module shown in FIG. 1.

FIG. 3 is a partial circuit diagram for explaining a circuit configuration of a three-level power converter.

FIG. 4 is a partial circuit diagram of a three-level power converter to which an inductance loop is added.

FIG. 5 is a partial circuit diagram of a three-level power converter according to the first embodiment.

FIG. 6 is a circuit diagram obtained by rewriting the circuit diagram in FIG. 5 such that switching elements in each group are adjacent to each other.

FIG. 7 is a circuit diagram in which two inductance loops are added to the circuit diagram in FIG. 6.

FIG. 8 is an explanatory diagram of an operation of the three-level power converter according to the first embodiment.

FIG. 9 are explanatory diagrams of an effect of configuring a dual-element power module with three terminals.

FIG. 10 is a top view schematically showing an example of a module arrangement in a three-level power converter using a dual-element power module according to a second embodiment of the present invention.

FIG. 11 is a top view schematically showing an example of a module arrangement in a three-level power converter using a dual-element power module according to a third embodiment of the present invention.

FIG. 12 is a cross-sectional view when viewed from the X direction of an arrow in FIG. 11.

FIG. 13 is a cross-sectional view when viewed from the Y direction of an arrow in FIG. 11.

### DESCRIPTION OF EMBODIMENTS

Exemplary embodiments of a three-level power converter according to the present invention will be explained below in detail with reference to the accompanying drawings. The present invention is not limited to the embodiments.

### First Embodiment

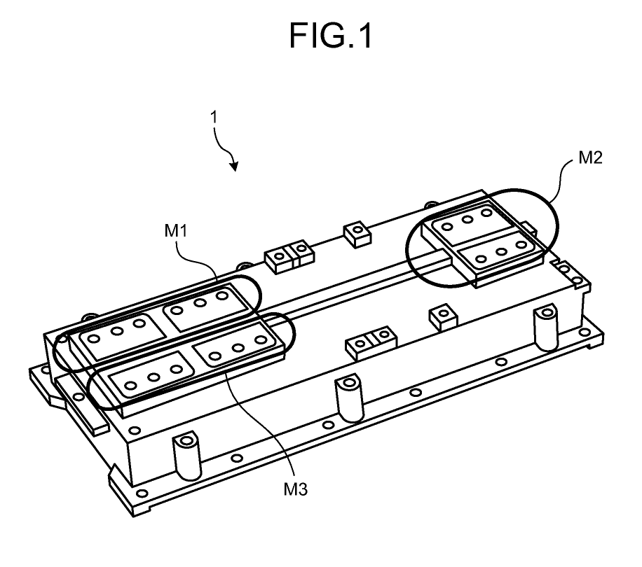

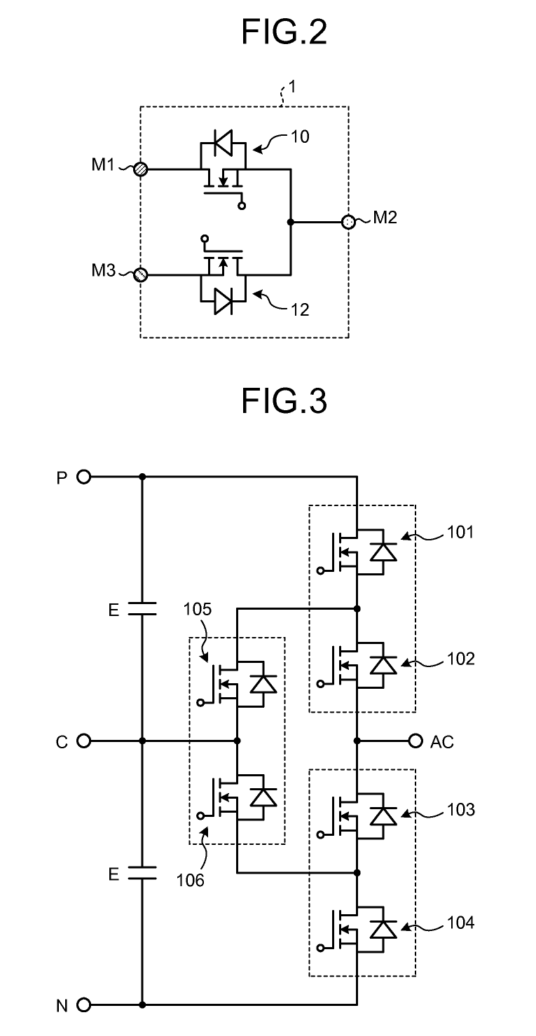

First, a dual-element power module according to a first embodiment of the present invention is explained with reference to FIGS. 1 and 2. FIG. 1 is a perspective view showing a schematic shape of the dual-element power module according to the first embodiment. FIG. 2 is a circuit diagram of the dual-element power module shown in FIG. 1.

As shown in FIGS. 1 and 2, a dual-element power module 1 according to the first embodiment has two pairs of elements that are a first element pair 10 and a second element pair 12 accommodated in a package (module casing). In each of the two pairs of elements, a MOSFET that serves as a switching element, and a diode that operates as a so-called flywheel diode (hereinafter, “FWD”) are connected in inverse parallel.

The first element pair 10 includes a first electrode M1 that is electrically connected to a connection portion (higher-side potential portion) where a drain of the MOSFET and a cathode of the FWD are electrically connected within the module, and a second electrode M2 that is electrically connected to a connection portion (lower-side potential portion) where a source of the MOSFET and an anode of the FWD are electrically connected within the module. In the second element pair 12, a drain of the MOSFET and a cathode of the FWD are electrically connected within the module, and this connection portion (higher-side potential portion) is electrically connected to the second electrode M2. The first element pair 10 also includes a third electrode M3 that is electrically connected to a connection portion (lower-side potential portion) where a source of the MOSFET and an anode of the FWD are electrically connected within the module. Also in the case of using a switching element other than the MOSFET, the cathode side of the FWD in a first element pair and a second element pair is referred to as “higher side” or “higher potential side”, and the anode side of the FWD in the first element pair and the second element pair is referred to as “lower side” or “lower potential side”.

The first to third electrodes are provided on one of the main-surface sides of the module casing. The first electrode and the third electrode are arrayed in a direction orthogonal to a longitudinal direction of the module casing on one of the end sides in the longitudinal direction, whereas the second electrode is arranged on the other end side in the longitudinal direction of the module casing.

In the manner as described above, the dual-element power module according to the first embodiment is configured as a triple-terminal module that includes three electrodes (terminals) that are the first electrode M1 to the third electrode M3 led out on the same main-surface side. A gate electrode (a terminal) is provided separately from the three electrodes.

Next, a three-level power converter using the power module according to the first embodiment is explained.

First, FIG. 3 is a partial circuit diagram for explaining the circuit configuration of the three-level power converter. FIG. 3 shows the configuration of a DC link unit and a power-conversion circuit unit for one phase in the three-level power converter that is preferably used for a railway vehicle. In the DC link unit, there are two capacitors that are connected in series, a higher-side DC terminal P that is connected to one end of the two capacitors, a lower-side DC terminal N that is connected to the other end, and an intermediate-potential terminal C that is connected to a point where the two capacitors are connected. The side where there is the higher-side DC terminal P is referred to as “higher potential side”, and the side where there is the lower-side DC terminal N is referred to as “lower potential side”. The power-conversion circuit unit for one phase selects any of the potentials of the higher-side DC terminal P, the intermediate-potential terminal C, and the lower-side DC terminal N, and outputs the selected potential to an AC terminal AC.

As shown in FIG. 3, the power-conversion circuit unit in the three-level power converter is configured by including: a switching element (hereinafter, “higher outer switching element”) 101 that is positioned on the outer side of the higher potential side; a switching element (hereinafter, “higher inner switching element”) 102 that is positioned on the inner side of the higher potential side; a switching element (hereinafter, “lower inner switching element”) 103 that is positioned on the inner side of the lower potential side; a switching element (hereinafter, “lower outer switching element”) 104 that is positioned on the outer side of the lower potential side; a switching element (hereinafter, “higher-side clamp element”) 105 that operates as a neutral-point clamp diode on the higher potential side; and a switching element (hereinafter, “lower-side clamp element”) 106 that operates as a neutral-point clamp diode on the lower potential side.

In the case where the power-conversion circuit unit that includes the six switching elements is configured by using the dual-element power modules, it is a general or typical concept to combine the higher outer switching element 101 and the higher inner switching element 102; combine the lower inner switching element 103 and the lower outer switching element 104; and combine the higher-side clamp element 105 and the lower-side clamp element 106, respectively, as shown in FIG. 3.

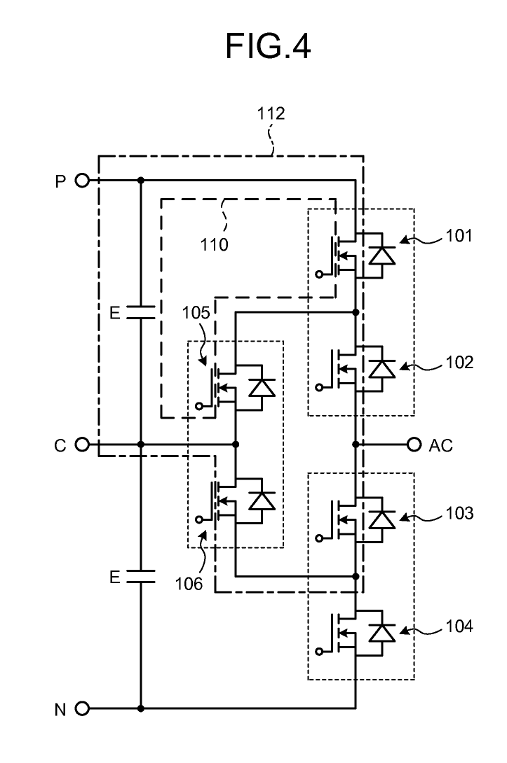

FIG. 4 is a circuit diagram in which loops (hereinafter, “inductance loops”) 110 and 112 that are vulnerable to a current change rate (di/dt), that is vulnerable to an inductance, are added to the circuit diagram in FIG. 3. While FIG. 4 shows an inductance loop between the higher-side DC terminal P and the intermediate-potential terminal C, it is apparent that a similar inductance loop is also formed between the lower-side DC terminal N and the intermediate-potential terminal C.

Referring to the inductance loops 110 and 112 shown in FIG. 4, both of the inductance loops 110 and 112 are formed straddling modules. Therefore, in order for the inductance loops 110 and 112 to have a low inductance, it is necessary to reduce not only the inductance component within a module, but also the inductance component in an electrical conductor that connects between modules. Accordingly, the groupings in the dual-element power modules shown in FIG. 3 are not advantageous from the viewpoint of achieving a low inductance in the inductance loops 110 and 112.

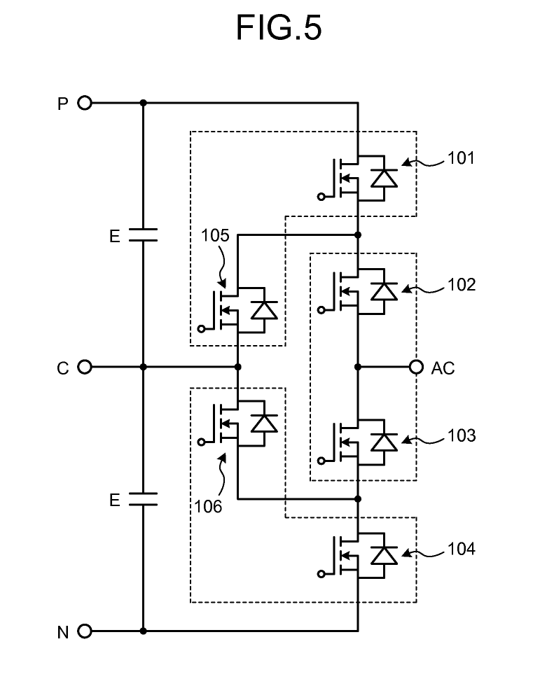

Meanwhile, FIG. 5 is a partial circuit diagram of the three-level power converter according to the first embodiment, in which the groupings are changed. Specifically, as shown in FIG. 5, the higher outer switching element 101 and the higher-side clamp element 105 are configured as a first group; the higher inner switching element 102 and the lower inner switching element 103 are configured as a second group; and the lower outer switching element 104 and the lower-side clamp element 106 are configured as a third group.

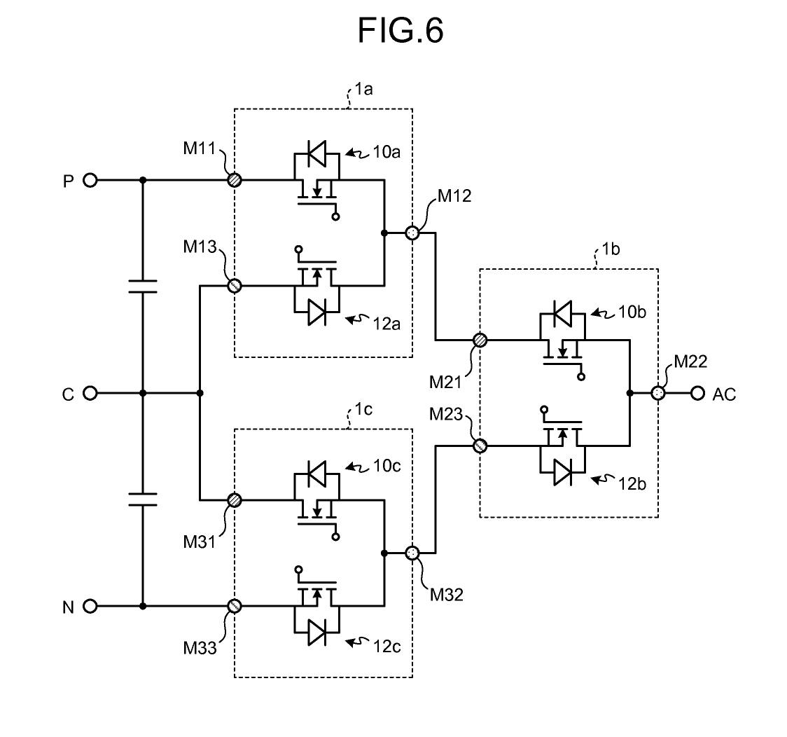

FIG. 6 is a circuit diagram obtained by rewriting the circuit diagram in FIG. 5 such that switching elements in each group are in proximity from each other. Specifically, a first group of a higher outer switching element 10a (hereinafter, simply “switching element 10a” to facilitate descriptions (the same applies to other switching elements)) and a higher-side clamp element 12a (also, simply “clamp element 12a” (the same applies to other clamp elements)) is configured by a dual-element power module 1a (also, simply “module 1a” (the same applies to other dual-element power modules)). A second group with a switching element 10b and a switching element 12b is configured by a module 1b. A third group with a clamp element 10c and a switching element 12c is configured by a module 1c.

A circuit for a single arm in the three-level power converter is configured in the following manner. A first electrode M11 in the module 1a and the higher-side DC terminal P are electrically connected. A second electrode M12 in the module 1a and a first electrode M21 in the module 1b are electrically connected. A third electrode M13 in the module 1a is electrically connected to the intermediate-potential terminal C. A first electrode M31 in the module 1c is electrically connected to the intermediate-potential terminal C. A second electrode M22 in the module 1b and the AC terminal AC are electrically connected. A third electrode M23 in the module 1b and a second electrode M32 in the module 1c are electrically connected. A third electrode M33 in the module 1c and the lower-side DC terminal N are electrically connected.

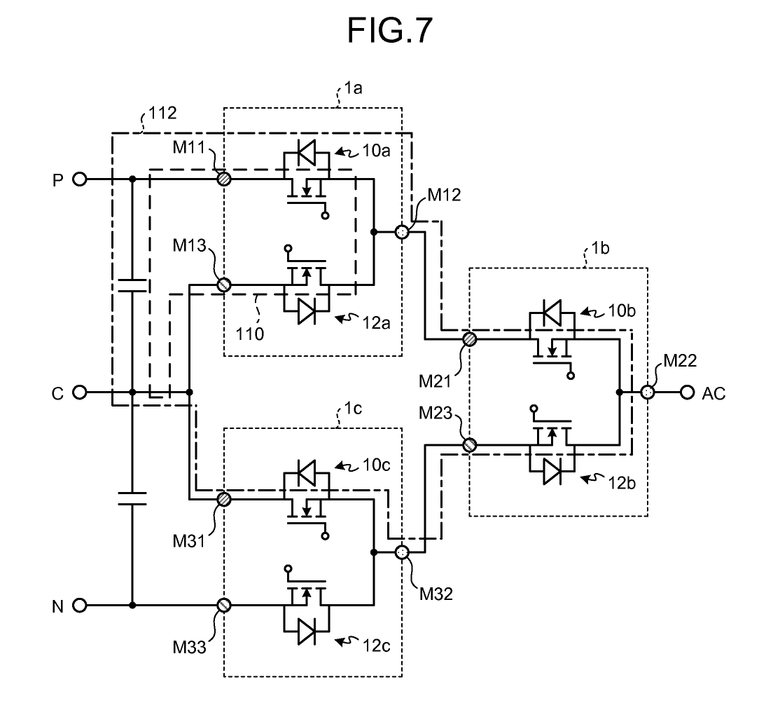

FIG. 7 is a circuit diagram in which the inductance loops 110 and 112 shown in FIG. 4 are added to the circuit diagram in FIG. 6. In the case of using the dual-element power module according to the first embodiment, as shown in FIG. 7, the path of the inductance loop 110, excluding a path extending through the DC link unit, is generated inside of the module. Therefore, assuming that the dual-element power module itself is configured to have a low inductance, the inductance loop 110 is inevitably a low-inductance circuit.

In the path of the inductance loop 112, a path extending through the DC link unit, a path connecting the first electrode M11 in the module 1a and the first electrode M21 in the module 1b, and a path connecting the third electrode M23 in the module 1b and the second electrode M32 in the module 1c, are generated outside of the modules as shown in FIG. 6. Therefore, assuming that the dual-element power module itself is configured to have a low inductance, and these three paths are configured to have a low inductance, the inductance loop 112 is inevitably a low-inductance circuit.

Inside the module 1, a current flows between the first electrode M1 and the second electrode M2, or between the second electrode M2 and the third electrode M3. Because the first electrode M1 and the third electrode M3 are arranged in proximity from each other, the distance between the current path from the first electrode M1 to the second electrode M2, and the current path from the second electrode M2 to the third electrode M3 can be reduced. Magnetic fluxes, generated by currents flowing through these current paths, cancel each other out. Therefore, the dual-element power module according to the first embodiment has a low-inductance circuit configuration.

The dual-element power module according to the first embodiment configured as described above can also be configured to be capable of reducing not only the inductance component within the module, but also the inductance component between the modules, by means of the module arrangement (a planar arrangement or a three-dimensional arrangement). This point will be described later in second and third embodiments.

Next, an operation of the three-level power converter configured by the dual-element power module according to the first embodiment is explained. Through this explanation, low-inductance characteristics specific to the dual-element power module are also explained.

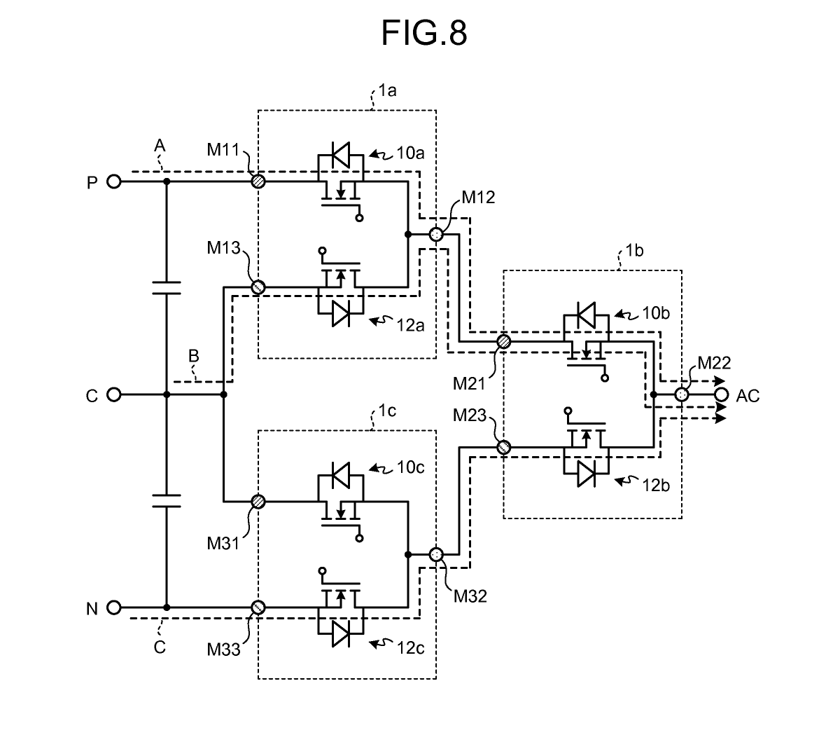

FIG. 8 is an explanatory diagram of an operation of the three-level power converter according to the first embodiment. FIG. 8 shows the circuit diagram in FIG. 6 with current paths added. In the following explanations, there is described a case as an example, in which a current that is output from the AC terminal AC that constitutes an AC terminal of a three-level power converter is positive (rightward).

First, when the switching elements 10a and 10b are turned ON, and the switching elements 12b and 12c are turned OFF, the voltage of the higher-side DC terminal P is output to the AC terminal AC. A current flows from the higher-side DC terminal P to the AC terminal AC, or flows from the AC terminal AC to the higher-side DC terminal P, through the switching elements 10a and 10b (a current path A).

Next, when the switching element 10a is turned OFF, and the switching element 12b is turned ON, the voltage of the intermediate-potential terminal C is output to the AC terminal AC. A current flows from the intermediate-potential terminal C through the clamp element 12a (specifically, a clamp diode) to the switching element 10b, and is then output to the AC terminal AC (a current path B). When a current flows from the AC terminal AC to the intermediate-potential terminal C, the current flows through the switching element 12b to the clamp element 10c (specifically, a clamp diode). When the switching element 10b is turned OFF, and the switching element 12b is turned ON, the voltage of the lower-side DC terminal N is output to the AC terminal AC. A current flows from the lower-side DC terminal N to the AC terminal AC, or flows from the AC terminal AC to the lower-side DC terminal N, through the switching elements 12b and 12c (a current path C).

As described above, the switching elements 10a, 10b, 12b, and 12c are brought into any of the following ON/OFF states:

State P: switching element 10a: ON, switching element 10b: ON, switching element 12b: OFF, switching element 12c: OFF;

State C: switching element 10a: OFF, switching element 10b: ON, switching element 12b: ON, switching element 12c: OFF;

State N: switching element 10a: OFF, switching element 10b: OFF, switching element 12b: ON, switching element 12c: ON.

According to changes in the ON/OFF state of switching elements, a current that flows through the switching elements changes. In view of both positive and negative currents that are a current flowing out from the AC terminal AC and a current flowing into the AC terminal AC, a current flowing through switching elements is commutated in such a manner that a current having flowed through the switching element 10a flows through the clamp element 12a. A current is commutated also between the switching element 10b and the switching element 12b. A current is commutated also between the switching element 12c and the clamp element 10c.

In the three-level power converter according to the first embodiment, the dual-element power module is configured by a combination of these switching elements through which the commutated current flows. Therefore, in the three-level power converter according to the first embodiment, the module arrangement thereof can contribute to achieving a low-inductance circuit required for the railway-vehicle three-level power converter.

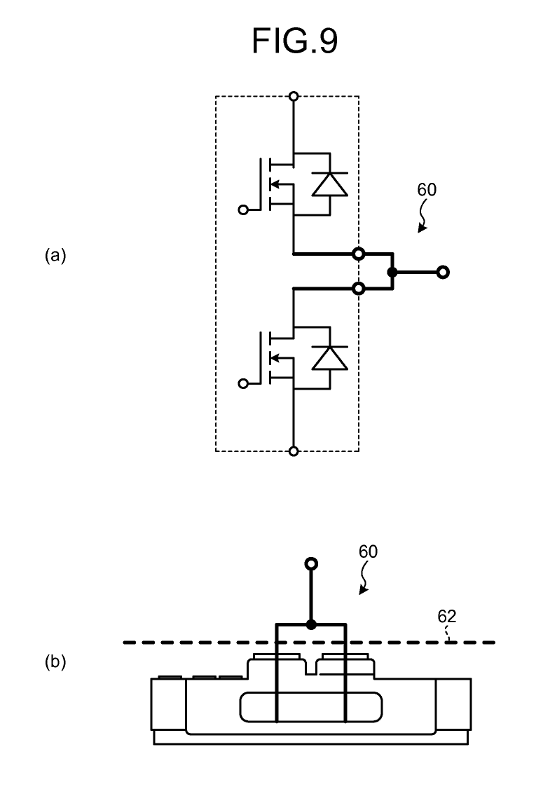

Next, the effects resulting from a dual-element power module configured by three terminals are explained. FIG. 9 are explanatory diagrams of the effects resulting from a dual-element power module configured by three terminals.

In FIG. 9, a dual-element power module is configured by four terminals. In the case of using the dual-element power module in a power converter such as a three-level power converter, an AC terminal unit 60 needs to be connected externally. Therefore, the AC terminal unit 60 and a PN connection conductor 62 (a DC wire for connecting a DC link unit and each switching element) vie for a space with o each other. In this case, as shown in FIG. 9(b) for example, when the wiring is carried out while bypassing the PN connection conductor 62, the length of a connection conductor of the AC terminal unit 60 is inevitably increased. Accordingly, an increase in inductance is inevitable. In contrast, as described in the present embodiment, in the case of a dual-element power module configured by three terminals, a lower potential electrode in one of element pairs, and a higher potential electrode in the other element pair are connected internally. Consequently, it is unnecessary to consider about wiring such as bypassing the PN connection conductor 62, and also an increase in length of the connection conductor of the AC terminal unit 60 can be suppressed. Significant effects on reducing the inductance can therefore be obtained.

As described above, the dual-element power module according to the first embodiment is configured to include first and second element pairs, in each of which a diode and a switching element are connected in inverse parallel, and to include a first electrode that is connected to a higher-side potential portion of the first element pair, a second electrode that is connected to a connection portion between a lower-side potential portion of the first element pair and a higher-side potential portion of the second element pair, and a third electrode that is connected to a lower-side potential portion of the second element pair, where the first to third electrodes in the dual-element power module are provided on one of the main-surface sides of a module casing, the first electrode and the third electrode are arrayed in a direction orthogonal to a longitudinal direction of the module casing on one of the end sides in the longitudinal direction, and the second electrode is arranged on the other end side in the longitudinal direction of the module casing. Therefore, it is possible to achieve a lower-inductance circuit as compared to a quadruple-terminal module.

The three-level power converter according to the first embodiment includes a power-conversion circuit unit that includes a first dual-element power module that includes an outer switching element on the higher potential side and a clamp element on the higher potential side, a second dual-element power module that includes an inner switching element on the higher potential side and an inner switching element on the lower potential side, and a third dual-element power module that includes an outer switching element on the lower potential side and a clamp element on the lower potential side, where the first to third dual-element power modules are dual-element triple-terminal power modules with the same configuration, each of which includes a first electrode that is connected to a higher-side potential portion of one of elements, a second electrode that is connected to a connection portion between a lower-side potential portion of the one of the elements and a higher-side potential portion of the other element, and a third electrode that is connected to a lower-side potential portion of the other element, and where the first electrode in the first dual-element power module is connected to the higher-side DC terminal, the second electrode in the first dual-element power module and the first electrode in the second dual-element power module are connected, the third electrode in the first dual-element power module is connected to an intermediate-potential terminal, the first electrode in the third dual-element power module is connected to the intermediate-potential terminal, the second electrode in the second dual-element power module is connected to the AC terminal, the third electrode in the second dual-element power module and the second electrode in the third dual-element power module are connected, and the third electrode in the third dual-element power module is connected to the lower-side DC terminal. Therefore, it is possible to achieve a low-inductance circuit by using three dual-element power modules with the same configuration.

According to the three-level power converter of the first embodiment, a railway-vehicle three-level power converter can be configured by using one type of power module. This is effective to reduce design costs and manufacturing costs.

### Second Embodiment

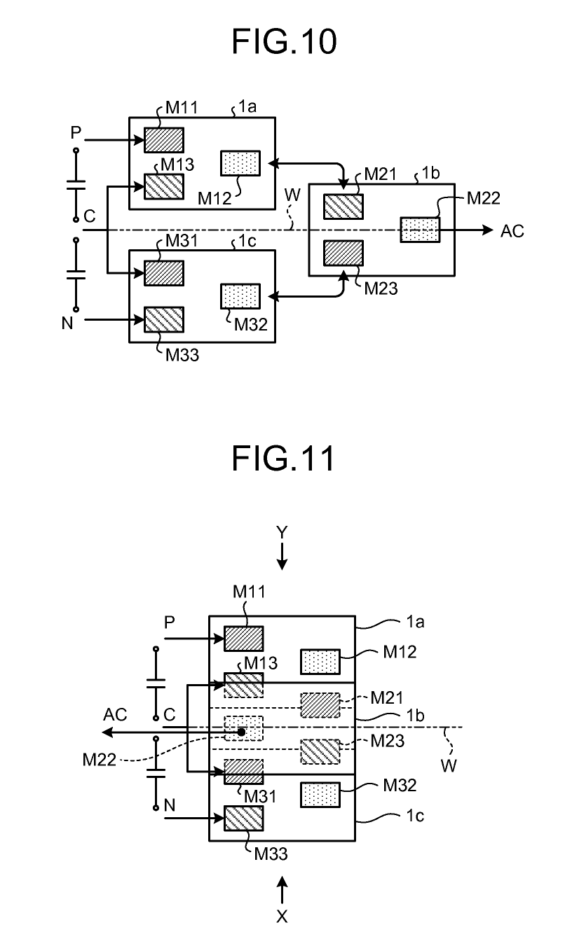

FIG. 10 is a top view schematically showing an example of a module arrangement in a three-level power converter using a dual-element power module according to a second embodiment of the present invention. In FIG. 10, in the example of the module arrangement according to the second embodiment, modules 1a to 1c that constitute the three-level power converter are arranged on a plane. The modules 1a to 1c correspond to the modules 1a to 1c shown in FIG. 6, respectively.

The module 1a and the module 1c are arranged such that the longitudinal side-surfaces of their respective module casings are adjacent to each other. Electrodes in each of the modules are arranged so as to be aligned in a direction orthogonal to a center plane W between the module 1a and the module 1c shown by a dot-and-dash line. The center plane W is a plane with equal distance from the center of the module 1 a and the center of the module 1c. While being shown by a line in FIG. 10, the center plane W is a plane extending in a direction vertical to the plane of the drawing sheet.

More specifically, a first electrode M11 and a third electrode M13 in the module 1 a, and a first electrode M31 and a third electrode M33 in the module 1c are arranged so as to be aligned in a direction orthogonal to the center plane W.

In the case of using the same modules as the module 1a and the module 1c, and arranging them in the manner as described above, then a second electrode M12 in the module 1a and a second electrode M32 in the module 1c are inevitably aligned in a direction orthogonal to the center plane W. Therefore, a group of the second electrode M12 in the module 1a and the second electrode M32 in the module 1c may be arranged so as to be aligned in a direction orthogonal to the center plane W.

In contrast to the modules 1a and 1c arranged in the manner as described above, the module 1b is arranged in the following manner. The module 1b is parallel to the center plane W that is a plane passing through the center of the module casing, and parallel to the longitudinal direction. The second electrode M22 is positioned on the center plane W. The first electrode M21 and the third electrode M23 in the module 1b are symmetrical with respect to the center plane W. The side surface of the module casing of the module 1b, on a side where the first electrode M21 and the third electrode M23 are provided, is adjacent to the side surface of the module casing of the module 1a (the module 1c) on a side where the second electrode M12 (the second electrode M32 in the module 1c) is provided. The second electrode M22 is positioned on the center plane W, which means that any portion of the second electrode M22 is located on the center plane W.

By arranging the modules 1 a to 1c in the manner as described above, an electrical wire that connects the second electrode M12 in the module 1a and the first electrode M21 in the module 1b, and an electrical wire that connects the third electrode M23 in the module 1b and the second electrode M32 in the module 1c, are wired with a very short path. Therefore, the three-level power converter with the modules 1a to 1c arranged therein can be configured by a low-inductance circuit. In FIG. 10 and other drawings, the locations of electrical wires are shown by arrowed lines.

Because modules with the same structure are used, and the second electrode M22 in the module 1b is arranged on the center plane W, an electrical wire that connects the second electrode M12 in the module 1a and the first electrode M21 in the module 1b, and an electrical wire that connects the third electrode M23 in the module 1b and the second electrode M32 in the module 1c, can have equal length, and thus a symmetrical circuit can be configured. While in FIG. 10, the outer shape of the module casing is a rectangle when viewed from the top, the outer shape of the module casing may be a trapezoid, a parallelogram, or other shapes when viewed from the top.

### Third Embodiment

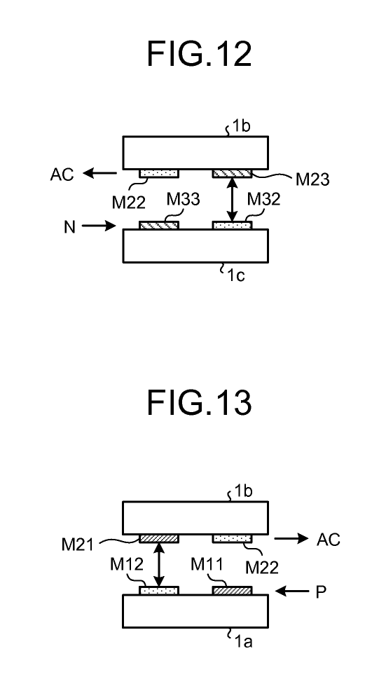

FIG. 11 is a top view schematically showing an example of a module arrangement in a three-level power converter using a dual-element power module according to a third embodiment of the present invention. FIG. 12 is a cross-sectional view when viewed from the X direction of an arrow in FIG. 11. FIG. 13 is a cross-sectional view when viewed from the Y direction of an arrow in FIG. 11.

When the arrangement example in FIGS. 11 to 13 according to the third embodiment is compared with the arrangement example in FIG. 10 according to the second embodiment, the module 1b is arranged differently. In the second embodiment, the module 1b is arranged on the same plane as the modules 1a and 1c. However, in the third embodiment, the electrode mounting surface of the module 1b is arranged so as to face (be opposed to) the electrode mounting surfaces of the modules 1a and 1c.

In addition to the above point, when the electrode mounting surfaces of the modules 1a and 1c are viewed from the back side of the electrode mounting surface of the module 1b in perspective plan view, the first electrode M11 and the third electrode M13 in the module 1a, the first electrode M31 and the third electrode M33 in the module 1c, and the second electrode M22 in the module 1b are aligned in a direction orthogonal to the center plane W between the module 1a and the module 1c, and the second electrode M22 in the module 1b is arranged so as to be positioned on the center plane W.

In the case of using the same modules as the first to third modules 1a to 1c, and arranging them in the manner as described above, when the electrode mounting surfaces of the modules 1a and 1c are viewed from the back side of the electrode mounting surface of the module 1b in perspective plan view, the second electrode M12 in the module 1a, the second electrode M32 in the module 1c, and the first electrode M21 and the third electrode M23 in the module 1b are aligned in a direction orthogonal to the center plane W between the module 1a and the module 1c.

By arranging the modules 1a to 1c in the manner as described above, an electrical wire that connects the second electrode M12 in the module 1a and the first electrode M21 in the module 1b, and an electrical wire that connects the third electrode M23 in the module 1b and the second electrode M32 in the module 1c, are wired with a very short path. Therefore, the three-level power converter with the modules 1a to 1c arranged therein can be configured by a low-inductance circuit.

Further, by arranging the modules 1a to 1c in the manner as described above, an electric wire that connects the second electrode M12 in the module 1a and the first electrode M21 in the module 1b, and an electric wire that connects the third electrode M23 in the module 1b and the second electrode M32 in the module 1c, can have equal length, and thus a symmetrical circuit can be configured.

The configuration of the dual-element power module shown in the first to third embodiments described above is merely an example, and various changes are possible. For example, while FIG. 11 illustrates the case where the module 1b is arranged above the modules 1a and 1c, the module 1b may be arranged below the modules 1a and 1c. These modules may be arranged with a horizontal relationship in place of a vertical relationship. FIG. 1 and other drawings illustrate an example of the configuration in which the first electrode M1 to the third electrode M3 are arranged in a clockwise direction on the electrode surface. However, the first electrode M1 to the third electrode M3 may be arranged in a counterclockwise direction on the electrode surface.

### Fourth Embodiment

The maximum available ratings of a large-capacity power module to be used for a railway-vehicle power converter are 3300V/1500A, 4500V/1200A, and 6500V/750A, for example. Such a power module has a base size of 140 mm×190 mm due to the constraints such as bolt mounting and the control of flatness of a cooling surface. At present, these power modules are all configured as a single-element power module. As described above, a largest-capacity power device has a single element incorporated therein due to the mechanical constraints. Therefore, in order to easily realize the three-level power converter according to the first to third embodiments, it is desirable to use an intermediate-capacity power module.

Accordingly, in a fourth embodiment, as a semiconductor material to realize the dual-element power module according to the first to third embodiments, a wide bandgap semiconductor is used, such as SiC, GaN, or diamond. Using the wide bandgap semiconductor can reduce generated loss, and makes it possible to downsize the power module as compared to a power module with the same current rating and using a narrow bandgap semiconductor such as Si. That is, assuming that a wide bandgap semiconductor is used as a semiconductor material to realize the dual-element power module according to the first to third embodiments, in the case of configuring a large-capacity railway-vehicle power converter for example, the control of flatness of a cooler is facilitated, and therefore workability is improved.

The configurations described in the first to fourth embodiments are exemplary configurations of the present invention, and it is needless to mention that these configurations can be combined with other publicly known techniques and various modifications can be made without departing from the scope of the present invention.

### INDUSTRIAL APPLICABILITY

As described above, the present invention is useful as a dual-element power module capable of configuring a low-inductance circuit and a three-level power converter using the dual-element power module.

### REFERENCE SIGNS LIST

1, 1a, 1b, 1c dual-element power module, 10 first element pair, 12 second element pair, 10a, 101 higher outer switching element, 10b, 102 higher inner switching element, 12b, 103 lower inner switching element, 12c, 104 lower outer switching element, 12a, 105 higher-side clamp element, 10c, 106 lower-side clamp element, 60 AC terminal unit, 62 connection conductor, 110, 112 inductance loop, AC AC terminal, P higher-side DC terminal, C intermediate-potential terminal, N lower-side DC terminal, M1 first electrode, M2 second electrode, M3 third electrode, M11 first electrode (module 1a), M12 second electrode (module 1a), M13 third electrode (module 1a), M21 first electrode (module 1b), M22 second electrode (module 1b), M23 third electrode (module 1b), M31 first electrode (module c), M32 second electrode (module 1c), M33 third electrode (module 1c), W center plane.

1. A three-level power converter comprising a power-conversion circuit unit for one phase that selects any of potentials of a higher-side DC terminal, an intermediate-potential terminal, and a lower-side DC terminal, and that outputs the selected potential to an AC terminal, where the power-conversion circuit unit includes a first dual-element power module that includes an outer switching element on a higher potential side and a clamp element on the higher potential side, a second dual-element power module that includes an inner switching element on the higher potential side and an inner switching element on a lower potential side, and a third dual-element power module that includes an outer switching element on the lower potential side and a clamp element on the lower potential side, wherein
the first to third dual-element power modules are dual-element triple-terminal power modules with a same configuration, each of which includes a first electrode that is connected to a higher-side potential portion of one of elements, a second electrode that is connected to a connection portion between a lower-side potential portion of the one of the elements and a higher-side potential portion of the other element, and a third electrode that is connected to a lower-side potential portion of the other element, and
the first electrode in the first dual-element power module is connected to the higher-side DC terminal, the second electrode in the first dual-element power module and the first electrode in the second dual-element power module are connected, the third electrode in the first dual-element power module is connected to the intermediate-potential terminal, the first electrode in the third dual-element power module is connected to the intermediate-potential terminal, the second electrode in the second dual-element power module is connected to the AC terminal, the third electrode in the second dual-element power module and the second electrode in the third dual-element power module are connected, and the third electrode in the third dual-element power module is connected to the lower-side DC terminal.

2. The three-level power converter according to claim 1, wherein
the first to third electrodes in the first to third dual-element power modules are provided on one of main-surface sides of a module casing, and
the first electrode and the third electrode are arrayed in a direction orthogonal to a longitudinal direction of the module casing on one of end sides in the longitudinal direction, and the second electrode is arranged on the other end side in the longitudinal direction of the module casing.

3. The three-level power converter according to claim 2, wherein
the first and third dual-element power modules are arranged such that longitudinal side-surfaces of their respective module casings are adjacent to each other, and electrode mounting surfaces of the module casings are directed in a same direction, and
the second dual-element power module is arranged such that a center line of a module casing in a longitudinal direction extends parallel to a center plane between the first dual-element power module and the third dual-element power module.

4. The three-level power converter according to claim 3, wherein the second dual-element power module is arranged such that the second electrode is positioned on the center plane.

5. The three-level power converter according to claim 3, wherein in the second dual-element power module, the first electrode and the third electrode are arranged symmetrically with respect to the center plane.

6. The three-level power converter according to claim 3, wherein the second electrode in the first dual-element power module, and the second electrode in the third dual-element power module are arranged so as to be aligned in a direction orthogonal to the center plane.

7. The three-level power converter according to claim 3, wherein the second dual-element power module is arranged such that a side surface of a module casing of the second dual-element power module, on a side where the first and third electrodes are provided, is adjacent to side surfaces of module casings of the first and third duel-element power modules on a side where the second electrode is provided.

8. The three-level power converter according to claim 3, wherein
an electrode mounting surface of the second dual-element power module is arranged so as to be opposed to electrode mounting surfaces of the first and third dual-element power modules, and
when the electrode mounting surfaces of the first and third duel-element power modules are viewed from a back side of the electrode mounting surface of the second duel-element power module in perspective plan view, a first electrode and a third electrode in the first duel-element power module, a first electrode and a third electrode in the third duel-element power module, and a second electrode in the second duel-element power module are aligned in a direction orthogonal to the center plane, and a second electrode in the first duel-element power module, a second electrode in the third duel-element power module, and a first electrode and a third electrode in the second duel-element power module are aligned in a direction orthogonal to the center plane.

9. The three-level power converter according to claim 1, wherein elements that constitute the first to third dual-element power modules are formed of a wide bandgap semiconductor.

10. The three-level power converter according to claim 9, wherein the wide bandgap semiconductor is a semiconductor made of silicon carbide, a gallium nitride-based material, or diamond.

11. A dual-element power module configured to be applicable to a power-conversion circuit unit in a power converter, wherein
the dual-element power module is configured to include first and second element pairs, in each of which a diode and a switching element are connected in inverse parallel, and to include a first electrode that is connected to a higher-side potential portion of the first element pair, a second electrode that is connected to a connection portion between a lower-side potential portion of the first element pair and a higher-side potential portion of the second element pair, and a third electrode that is connected to a lower-side potential portion of the second element pair,
the first to third electrodes in the dual-element power module are provided on one of main-surface sides of a module casing, and
the first electrode and the third electrode are arrayed in a direction orthogonal to a longitudinal direction of the module casing on one of end sides in the longitudinal direction, and the second electrode is arranged on the other end side in the longitudinal direction of the module casing.

12. The dual-element power module according to claim 11, wherein the first and second element pairs are formed of a wide bandgap semiconductor.

13. The dual-element power module according to claim 12, wherein the wide bandgap semiconductor is a semiconductor made of silicon carbide, a gallium nitride-based material, or diamond.
